(19) United States
(12) Patent Application Publication
(10) Pub. No.: US 2007/0127708 A1
(43) Pub. Date: Jun. 7, 2007

(54) IP telephone apparatus and method of controlling the same

(76) Inventors: Takeshi Yamashita, Koganei-shi (JP); Takeshi Horiuchi, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/586,588

(22) Filed: Oct. 26, 2006

(30) Foreign Application Priority Data
Oct. 27, 2005 (JP) 2005-313301

(51) Int. Cl. H04M 1/00; H04M 9/00

(52) U.S. Cl. 379/388.03

(57) ABSTRACT

According to one embodiment, in an IP telephone apparatus, when docking detection means detects connection of an optional unit to a main unit, a controller calls up voice processing parameters stored in storage means, changes setting to the called voice processing parameters, and performs optimum voice processing by an acoustic echo canceller, another acoustic echo canceller, and a line echo canceller.

### CROSS-REFERENCE TO RELATED APPLICATIONS

This application is based upon and claims the benefit of priority from Japanese Patent Application No. 2005-313301, filed Oct. 27, 2005, the entire contents of which are incorporated herein by reference.

### BACKGROUND

1. Field

One embodiment of the present invention relates to an IP telephone apparatus and a method of controlling the same, with an improved performance obtained by connecting an optional unit to the IP telephone apparatus.

2. Description of the Related Art

With respect to IP telephone apparatuses, as disclosed in Jpn. Pat. Appln. KOKAI Pub. No. 9-172485, there is a technique of performing level control of AGC (Auto Gain Control) by providing a dedicated control device to improve performance of an echo canceller that deals with echoes of sounds and the like (refer to Jpn. Pat. Appln. KOKAI Pub. No. 9-172485).

However, in the above technique, it is necessary to provide a dedicated control device to perform level control of AGC, and there are problems such as increase in cost and in circuit area. Further, in the field of IP telephone apparatuses, there are increasing needs for cost reduction and better performance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view illustrating a system configuration of an IP telephone apparatus according to an embodiment of the present invention.

FIG. 2 is a block diagram illustrating a state where an optional unit is connected to a main unit being the IP telephone apparatus of the embodiment of the present invention.

FIG. 3 is a flow chart illustrating a control method applied to the IP telephone apparatus according to the embodiment of the present invention.

### DETAILED DESCRIPTION

Various embodiments according to the invention will be described hereinafter with reference to the accompanying drawings. In general, according to one embodiment of the invention, an IP telephone apparatus according to an aspect of the present invention comprises: a main unit including a storing section which stores voice processing parameters, a detecting section which detects connection of an optional unit, and a control section which has a first voice processing section; and an optional unit which has a second voice processing section and is connectable to the main unit, wherein when the detecting section detects connection of the optional unit to the main unit, the control section calls up the voice processing parameters stored in the storing section, changes setting of the apparatus to the called voice processing parameters, and perform optimum voice processing by the first voice processing section and the second voice processing section.

An embodiment of the present invention is explained below with reference to drawings.

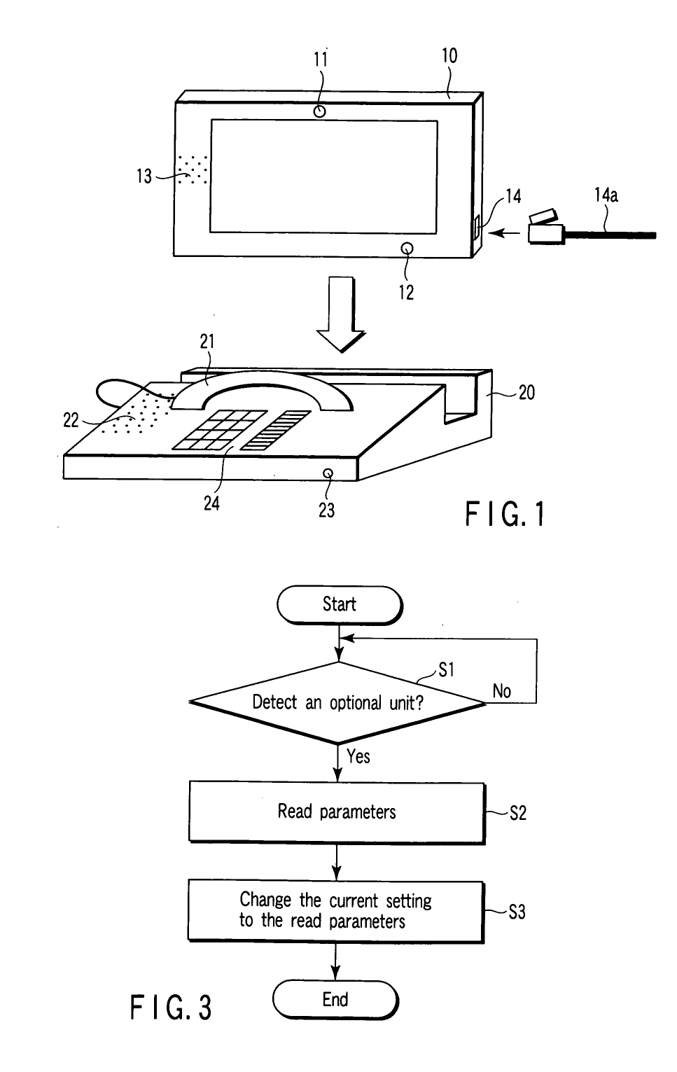

FIG. 1 is a perspective view illustrating a system configuration of an IP telephone apparatus according to an embodiment of the present invention. The IP telephone apparatus comprises a main unit 10, and an optional unit 20.

The main unit 10 comprises a camera 11, a microphone 12 as voice input means, a speaker 13 as voice output means, and a LAN connector 14 as communication means. A LAN cable 14a is connected to the LAN connector 14 to enable use of the IP telephone apparatus.

Further, the optional unit 20 is connectable to the main unit 10. The optional unit 20 comprises a hand set 21 as voice input means and voice output means, a speaker 22 as voice output means, a microphone 23 as voice input means, and push buttons 24. The speaker 22 and the microphone 23 have higher performances than those of the speaker 13 and the microphone 12, respectively, of the main unit 10. Further, a set of a speaker and a microphone having small acoustic coupling is used as the speaker and the microphone of each of the main unit and the optional unit.

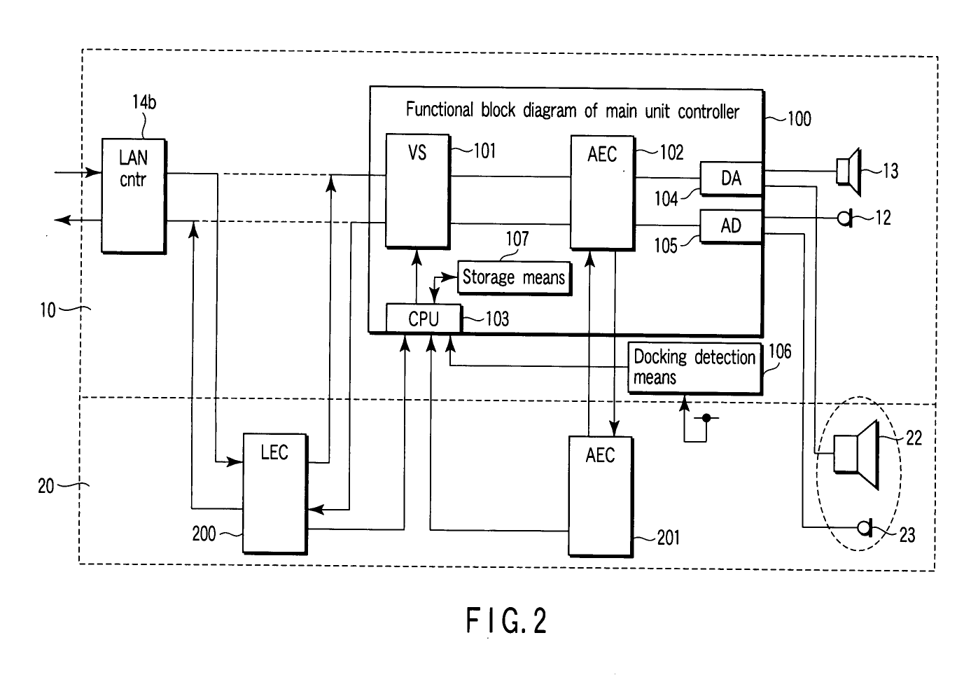

FIG. 2 is a block diagram illustrating a state where an optional unit 20 is connected to the main unit 10.

The main unit 10 comprises a controller 100, docking detection means 106 that detects connection of the optional unit 20, a LAN controller 14b that controls a LAN connected to the LAN connector 14, the speaker 13, and the microphone 12.

The controller 100 includes a voice switch 101 that performs switching of signals from the LAN controller 14b, an acoustic echo canceller (AEC) 102 that performs echo canceling of a signal that is passed through the voice switch 101, a D/A converter 104 that converts a digital signal processed by the acoustic echo canceller 102 into an analogue signal, the speaker 13 that outputs the analogue signal obtained by conversion by the D/A converter 104, the microphone 12 that inputs voice, an A/D converter 105 that converts an analogue signal input by the microphone 12 into a digital signal, storage means 107 that stores voice parameters and the like, and a CPU 103 that controls the controller 100 (the acoustic echo canceller 102 serves as first voice processing means).

The optional unit 20 comprises the speaker 22, the microphone 23, an acoustic echo canceller 201, and a line echo canceller 200, which become usable after connection with the main unit 10 (the acoustic echo canceller 201 and, if necessary, the line echo canceller 200 serve as second voice processing means).

Next, a method of controlling the IP telephone apparatus of the present invention is explained below with reference to the drawings. FIG. 3 is a flowchart illustrating the method of controlling the IP telephone apparatus.

The controller 100 of the main unit 10 of the IP telephone apparatus determines whether the optional unit 20 is connected to the main unit or not (step SI). If the controller 100 determines that the optional unit 20 is connected (YES of step S1), the controller 100 reads the voice parameters from the storage means 107 (step S2). Further, the controller 100 changes the current setting to the read parameters (step S3).

As described above, when the optional unit 20 is connected and the voice parameters are changed, the acoustic echo canceller 102 of the main unit 10 is connected to the acoustic echo canceller 201 of the optional unit 20, and the echo cancellers function as one integrated acoustic echo canceller.

Specifically, voice signals in the main unit 10 are voice-processed through the integrated acoustic echo canceller (the acoustic echo canceller 102 of the main unit 10 and the acoustic echo canceller 201 of the optional unit 20) and then the line echo canceller 200. Since a voice signal passes through the integrated acoustic echo canceller including the acoustic echo canceller 201 besides the acoustic echo canceller 102, the canceling time of the two acoustic echo cancellers 102 and 201 is applied to the voice signal. Therefore, it is possible to cancel an echo of a longer time in comparison with, for example, the case of using only the acoustic echo canceller 102. Further, it is possible to also use the line echo canceller 200 not included in the main unit 10, and thereby further improve the quality of the voice signal.

The following are examples of the voice parameters, although the voice parameters are not limited to them.

(1) to reduce the loss amount of the voice switch, since the canceling amount of the echo canceller increases

For example, the loss amount is reduced from 12 [dB] to 2 [dB]. Since the value “x[dB]” here indicates the loss amount, the volume is increased when the value is reduced.

Changing the above parameter improves the simultaneous conversation property, and reduces interruption of the party's voice on the other end of the line.

(2) to increase the transmission/reception gain

For example, the transmission/reception gain is increased from 0 [dB] to 6 [dB].

Since the value “x[dB]” here indicates the gain, the volume is increased when the value is increased.

Changing the above parameter increases the volume, and thus allows easier listening of the user's voice and facilitates telephone conversation.

(3) to increase the volume range

For example, the range is increased from 21 [steps]/40 [dB] to 24 [steps]/46 [dB].

Changing the above parameter increases the variable range of the volume, and enables the user to tune the apparatus to a more appropriate volume.

(4) Other examples of the parameters are balancing transmission/reception, setting a threshold for an acoustic state, and changing a loss amount of the voice switch (reduce the loss amount of the voice switch and improve a feeling of simultaneous conversation).

As described above, according the above embodiment, the IP telephone apparatus has a structure of being divided into the main unit and the optional unit. Thereby, it is possible to provide a high-performance IP telephone set that improves the performance of the echo canceller without a dedicated control device, and the IP telephone apparatus and the method of controlling the same, which are ready for IP telephone sets that achieve cost reduction.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An IP telephone apparatus comprising:
a main unit including a storing section which stores voice processing parameters, a detecting section which detects connection of an optional unit, and a control section which has a first voice processing section; and
an optional unit which has a second voice processing section and is connectable to the main unit,
wherein
when the detecting section detects connection of the optional unit to the main unit, the control section calls up the voice processing parameters stored in the storing section, changes setting of the apparatus to the called voice processing parameters, and perform optimum voice processing by the first voice processing section and the second voice processing section.

2. An IP telephone apparatus according to claim 1, wherein
the main unit further includes a first voice output section and a first voice input section, the optional unit further includes a second voice output section and a second voice input section,
when the control section changes the setting to the voice processing parameters, voice input and output are switched from the first voice output section and the first voice input section to the second voice output section and the second voice input section.

3. An IP telephone apparatus according to claim 2, wherein
the first voice processing section is an acoustic echo canceller.

4. An IP telephone apparatus according to claim 2, wherein
the second voice processing section is an acoustic echo canceller, and includes a line echo canceller according to necessity.

5. An IP telephone apparatus according to claim 2, wherein
the first voice output section is a speaker, the first voice input section is a microphone, the second voice output section is a speaker, and the second voice input section is a microphone, or the second voice output section and the second voice input section are a handset including a speaker and a microphone.

6. An IP telephone apparatus according to claim 3, wherein
when the control section changes the setting to the voice processing parameters and performs optimum voice processing by the first voice processing section and the second voice processing section, the control section performs control by using a canceling time obtained by summing up a canceling time of the acoustic echo canceller of the first voice processing section and a canceling time of the acoustic echo canceller of the second voice processing section.

7. An IP telephone apparatus according to claim 4, wherein
when the control section changes the setting to the voice processing parameters and performs optimum voice processing by the first voice processing section and the second voice processing section, the control section performs control by using a canceling time obtained by summing up a canceling time of the acoustic echo canceller of the first voice processing section and a canceling time of the acoustic echo canceller of the second voce processing section.

8. An IP telephone apparatus according to claim 5, wherein
a set of a speaker and a microphone having small acoustic coupling is used as the speaker and the microphone of each of the main unit and the optional unit.

9. A method of controlling an IP telephone apparatus, the IP telephone apparatus comprising a main unit including a storing section which stores voice processing parameters, a detecting section which detects connection of an optional unit, and a control section which has a first voice processing section, and an optional unit which has a second voice processing section and is connectable to the main unit,
the method comprising:
determining whether connection of the optional unit to the main unit is detected by the detecting section, and
calling up, by the control section, the voice processing parameters stored in the storing section, changing setting of the apparatus to the called voice processing parameters, and performing optimum voice processing by the first voice processing section and the second voice processing section, when the determining determines that connection of the optional unit to the main unit is detected by the detecting section.

10. A method according to claim 9, wherein
the main unit further includes a first voice output section and a first voice input section, the optional unit further includes a second voice output section and a second voice input section, and
the method further comprises:
switching voice input and output from the first voice output section and the first voice input section to the second voice output section and the second voice input section, when the control section changes the setting to the voice processing parameters.

11. A method according to claim 10, wherein
the first voice processing section is an acoustic echo canceller.

12. A method according to claim 10, wherein
the second voice processing section is an acoustic echo canceller, and includes a line echo canceller according to necessity.

13. A method according to claim 10, wherein
the first voice output section is a speaker, the first voice input section is a microphone, the second voice output section is a speaker, and the second voice input section is a microphone, or the second voice output section and the second voice input section are a handset including a speaker and a microphone.

14. A method according to claim 11, wherein
when the control section changes the setting to the voice processing parameters and performs optimum voice processing by the first voice processing section and the second voice processing section, the control section performs control by using a canceling time obtained by summing up a canceling time of the acoustic echo canceller of the first voice processing section and a canceling time of the acoustic echo canceller of the second voice processing section.

15. A method according to claim 12, wherein
when the control section changes the setting to the voice processing parameters and performs optimum voice processing by the first voice processing section and the second voice processing section, the control section performs control by using a canceling time obtained by summing up a canceling time of the acoustic echo canceller of the first voice processing section and a canceling time of the acoustic echo canceller of the second voce processing section.

16. A method according to claim 13, wherein
a set of a speaker and a microphone having small acoustic coupling is used as the speaker and the microphone of each of the main unit and the optional unit.
